(19) United States
(12) Patent Application Publication
(10) Pub. No.: US 2009/0175428 A1
(43) Pub. Date: Jul. 9, 2009

(54) Method for Managing Transient Telephone Contacts

(75) Inventors: Michael N. Abernethy, JR., Pflugerville, TX (US); Travis M. Grigsby, Austin, TX (US); Frank L. Jania, Chapel Hill, NC (US)

Correspondence Address: CANTOR COLBURN LLP - IBM LOTUS, 20 Church Street, 22nd Floor, Hartford, CT, 06103, US

(73) Assignee: International Business Machines Corporation, Armonk, NY (US)

(21) Appl. No.: 11/969,489

(22) Filed: Jan. 4, 2008

(51) Int. Cl. H04M 1/56

(52) U.S. Cl. 379/142.04

(57) ABSTRACT

A method for managing transient telephone contacts including capturing a telephone call identifying information related to a telephone communication, associating the telephone call identifying information with a telephone number related to the telephone communication, and providing the telephone call identifying information in response to a telephone operation involving the telephone number.

### BACKGROUND OF THE INVENTION

1. Field of the Invention

This invention relates generally to telecommunications, and particularly to a method for managing transient telephone contacts.

2. Description of Background

Telephones (or “phones”), particularly mobile phones, typically include a feature known as an address book in which phone call contact information (“contacts”) such as a phone number and corresponding caller name and/or other identifying information can be input and stored (e.g., “programmed”) by a user. Mobile phones are typically not capable of displaying a caller name or other identifying information that corresponds to an incoming phone number or an outgoing phone number (e.g., that is entered or selected for dialing) unless the number matches that of a programmed contact that includes such information. However, some contacts (i.e., “transient contacts”) are not programmed into an address book, for example, because a user does not anticipate utilizing the contact to make or receive a call frequently enough to justify the time, effort, memory usage, etc. involved. Thus, a caller name or other identifying information will not be available to display for a corresponding incoming or outgoing phone number for such transient contacts. Yet, it is desirable for a mobile phone (or other types of phones with similar functionality) to provide a caller name and/or other identifying information that corresponds to an incoming or outgoing phone number for transient contacts, for example, in the event that they are utilized.

### SUMMARY OF THE INVENTION

A method for managing transient telephone contacts is provided. An exemplary embodiment of the method includes capturing a telephone call identifying information related to a telephone communication, associating the telephone call identifying information with a telephone number related to the telephone communication, and providing the telephone call identifying information in response to a telephone operation involving the telephone number.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a telecommunications system including an exemplary telephone device configured for managing transient telephone contacts.

FIG. 2 is a flow diagram illustrating an example of a method for managing transient telephone contacts executable, for example, on the exemplary telephone device of FIG. 1.

The detailed description explains the preferred embodiments of the invention, together with advantages and features, by way of example with reference to the drawings.

### DETAILED DESCRIPTION OF THE INVENTION

According to exemplary embodiments of the invention described herein, a method for managing transient telephone contacts is provided. In accordance with such exemplary embodiments, identifying information for a telephone contact that is transient, and therefore not stored in an address book, can be provided for a related telephone number on a telephone device that is otherwise not capable of providing such information.

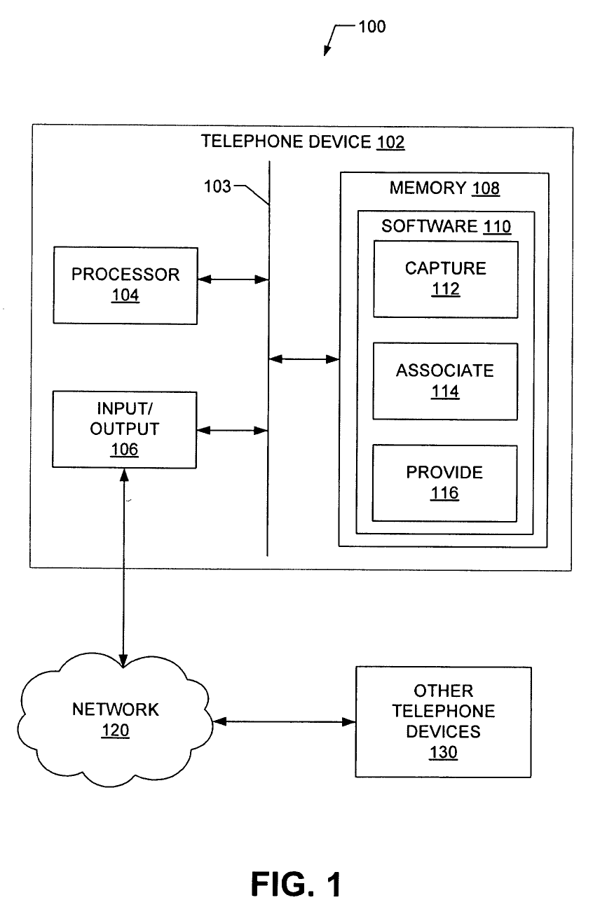

Turning now to the drawings in greater detail, wherein like reference numerals indicate like elements, FIG. 1 illustrates an example of a telecommunications system 100 including an exemplary telephone device 102 configured for managing transient telephone contacts. In addition to telephone device 102, exemplary telecommunications system 100 includes telecommunications network 120 and other telephone devices 130. Telecommunications network 120 connects telephone device 102 and other telephone devices 130 and may include a wireless medium and related telecommunications equipment, such as a tower, antenna, transmitter, etc. (not depicted). Other telephone devices 130 may include one or more devices like telephone device 102 and/or other applicable telephone devices and/or telecommunications equipment.

Exemplary telephone device 102 includes processor 104, input/output components 106, and memory 108, which are in communication via bus 103. Input/output components 106 may include components that facilitate local and/or remote input/output operations to/from telephone device 102, such as a display, keypad, microphone, speaker, transmitter, antenna, etc. (not depicted). Memory 108 includes software 110 for managing transient telephone contacts, which is executable by telephone device 102 via processor 104. Software 110 includes modules for managing transient telephone contacts, including capture module 112, associate module 114, and provide module 116. An exemplary operation of these modules 112, 114, 116 will be described below. Memory 108 may include other software, modules, etc. (not depicted).

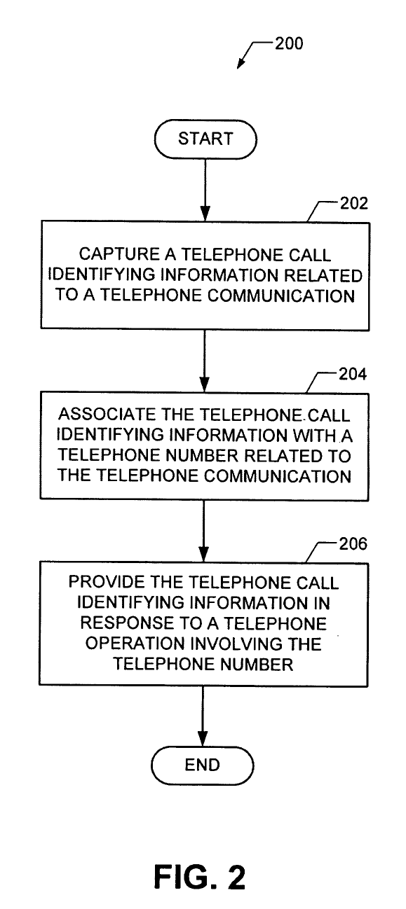

FIG. 2 illustrates an example of a method 200 for managing transient telephone (or “phone”) contacts executable, for example, on the exemplary telephone device 102 of FIG. 1. Such transient telephone contacts may include a telephone number and a corresponding telephone caller name and/or other identifying information that has not been programmed to a telephone device address book, e.g., because it was not anticipated to be utilized frequently enough to justify programming it. In block 202, telephone call identifying information related to a telephone communication is captured. This may be performed, e.g., by capture module 112 of software 110 executed on telephone device 102. Such telephone call identifying information may include a telephone caller name and/or other identifying information. The telephone communication may be a telephone call, a telephone voice mail access, or other telephone related communication.

In some embodiments, capturing telephone call identifying information in accordance with block 202 may include creating a recording of a duration of a communication during a telephone call. For example, a three, five, ten, etc. second duration of the beginning, end, or some other portion of a phone call conversation may be recorded in this regard. In other embodiments, capturing telephone call identifying information in accordance with block 202 may include creating a recording of a remark related to a telephone call. For example, a telephone user may be prompted for a remark input before, after, or at some point during a telephone call, where the remark may include a telephone caller name and/or other identifying information and be of some duration, such as three, five, ten, etc. seconds. The above recordings may be input, e.g., via a microphone or other input component of telephone device 102.

In block 204, the telephone call identifying information is associated with a telephone number related to the telephone communication. This may be performed, e.g., by associate module 114 of software 110 executed on telephone device 102. In some embodiments, associating the telephone call identifying information may include linking it to a telephone number of a telephone call. For example, a recording of a duration of a communication during a telephone call (e.g., created in accordance with exemplary embodiments of block 202) may be linked to a telephone number of the telephone call in this regard. As another example, a recording of a remark related to a telephone call (e.g., created in accordance with exemplary embodiments of block 202) may be linked to a telephone number of the telephone call in this regard.

In block 206, the telephone identifying information is provided in response to a telephone operation involving the telephone number. This may be performed, e.g., by provide module 116 of software 110 executed on telephone device 102. In some embodiments, providing the telephone call identifying information may include playing the above described duration recording in response to receiving an incoming telephone call from the telephone number or in response to entering or selecting the number (e.g., to make an outgoing call), e.g., via telephone device 102, whereby the incoming call or the telephone number are identified by the recording. In other embodiments, providing the telephone call identifying information may include playing the above described remark recording in response to receiving an incoming telephone call from the telephone number or in response to entering or selecting the number (e.g., to make an outgoing call), e.g., via telephone device 102, whereby the incoming call or the telephone number are identified by the recording. For example, such recording may be played back over a speaker or other output component of telephone device 102 to serve as a ringer for an incoming call, where in some embodiments, this playback may be initiated and/or stopped by a user input (e.g., for privacy or discretion purposes).

As described above, exemplary method 200 for managing transient telephone contacts may be performed by telephone device 102, which may be a mobile phone or similarly functioning device. Furthermore, one or more of the operations described above with respect to method 200 may be performed locally or remotely to such telephone device 102. For example, the capturing and associating operations may be performed locally by a telephone device 102 or remotely via telephone device 102 by one or more other telecommunication devices that are in communication with the mobile phone, such as other telephone devices 130.

Exemplary telecommunications system 100 and telephone device 102 are illustrated and described with respect to various components, modules, etc. for exemplary purposes. It should be understood that other variations, combinations, or integrations of such elements that provide the same features, functions, etc. are included within the scope of embodiments of the invention.

The flow diagram described herein is just an example. There may be many variations to this diagram or the blocks (or operations) thereof without departing from the spirit of embodiments of the invention. For instance, the blocks may be performed in a differing order, or blocks may be added, deleted or modified. All of these variations are considered a part of the claimed invention. Furthermore, although an exemplary execution of the flow diagram blocks is described with respect to the exemplary telecommunications system 100 and telephone device 102, execution of the flow diagram blocks may be implemented with other hardware and/or software architectures that provide the same features, functions, etc. in accordance with exemplary embodiments of the invention.

Exemplary embodiments described above can be implemented by a circuit that is part of a design for an integrated circuit chip. This chip design can be created in a graphical computer programming language and stored in a computer storage medium (such as a disk, tape, physical hard drive, or virtual hard drive, such as in a storage access network). If the chip designer does not fabricate chips or the photolithographic masks used to fabricate chips, the designer may transmit the resulting design by physical means (e.g., by providing a copy of the storage medium storing the design) or electronically (e.g., through the Internet) to the corresponding entity, directly or indirectly. The stored design can then be converted into an appropriate format (e.g., GDSII) for the fabrication of photolithographic masks, which typically include multiple copies of the chip design to be formed on a wafer. The photolithographic masks can be utilized to define areas of the wafer (and/or the layers thereon) to be etched or otherwise processed to fabricate chips.

The resulting integrated chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has surface interconnections and/or buried connections). In any case, the chip is then integrated with other chips, discrete circuit elements, and/or other signal processing devices as part of either (a) any intermediate product, such as a motherboard, or (b) an end product. The end product can be any product that includes integrated circuit chips, ranging from toys and other low-end applications to advanced computer products having a display, a keyboard or other input device, and a central processor.

Additionally, exemplary embodiments described above can be implemented in hardware, software, or a combination of both. Those embodiments implemented in software may, for example, include firmware, resident software, microcode, etc. Exemplary embodiments of the invention may also be implemented as a computer program product accessible from a computer-usable or computer-readable medium providing program code for use by or in connection with a computer or other instruction execution system. In this regard, a computer-usable or computer-readable medium can be any apparatus that can contain, store, communicate, propagate, or transport the program for use in connection with the instruction execution system, apparatus, or device.

The computer-usable or computer-readable medium can be an electronic, magnetic, optical, electromagnetic, infrared, or semiconductor system (apparatus, device, etc.) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Some current examples of optical disks include compact disk-read only memory (CD-ROM), compact disk-read/write (CD-R/W), or digital video disk (DVD).

A data processing system suitable for storing and/or executing program code can include at least one processor coupled directly or indirectly to memory elements through a system bus. The memory elements can include local memory employed during actual execution of the program code, bulk storage, or cache memories that provide temporary storage of at least some program code to reduce the number of times the code needs to be retrieved from bulk storage during execution.

Input/output (I/O) devices (e.g., keyboards, displays, pointing devices, etc.) can be coupled to the data processing system either directly or through intervening I/O controllers. Network adapters may also be coupled to the data processing system to allow the system to be coupled to other data processing systems or remote printers or storage devices through intervening private or public networks. Telephonic modems, cable modems, and ethernet cards are a few examples of the currently available types of network adapters.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A method for managing transient telephone contacts, the method comprising:
capturing a telephone call identifying information related to a telephone communication, wherein the capturing comprises creating a recording of a duration of a communication during a telephone call or of a remark related to the telephone call;
associating the telephone call identifying information with a telephone number related to the telephone communication, wherein the associating comprises linking the telephone number of the telephone call to the recording; and
providing the telephone call identifying information in response to a telephone operation involving the telephone number;
wherein the capturing, associating, and providing is performed via a telephone device.

2. The method of claim 1, wherein providing the telephone call identifying information comprises playing the recording in response to receiving an incoming telephone call from the telephone number, wherein the incoming telephone call is identified by the recording.

3. The method of claim 2, wherein playing the recording further comprises playing the recording in response to receiving an incoming telephone call from the telephone number upon receiving an initiation input.

4. The method of claim 1, wherein providing the telephone call identifying information comprises playing the recording in response to entering or selecting the telephone number, wherein the telephone number is identified by the recording.

5. The method of claim 1, wherein submission of the remark is prompted for after the telephone call.
